(19) United States
(12) Patent Application Publication
(10) Pub. No.: US 2005/0063613 A1
(43) Pub. Date: Mar. 24, 2005

(54) Network based system and method to process images

(76) Inventors: Kevin Casey, Newtown, PA (US); Norm Racine, Richboro, PA (US)

Correspondence Address: Daniel H. Golub;Morgan, Lewis & Bockius, LLP, 1701 Market Street, Philadelphia, PA, 19103, US

(21) Appl. No.: 10/950,269

(22) Filed: Sep. 24, 2004

Related U.S. Application Data
(60) Provisional application No. 60/506,007, filed on Sep. 24, 2003.

(51) Int. Cl. G06K 9/60; G06K 9/36

(52) U.S. Cl. 382/305; 382/276

(57) ABSTRACT

A file is uploaded to the system provider. The uploaded file contains at least one of color images scanned from film photographed at an event, black and white images scanned from film photographed at the event and digitally captured images photographed at the event and a text data file. Images from the uploaded file are sorted, via a graphical user interface, into a series of images based on a user defined sorting sequence. After the sorting, at least one image product is selected, via the graphical user interface. The image product is comprised of at least one of an event web site, a client proofing product, a CD/DVD slide show, a proof book and proofs. After the selecting, one or more image product categories corresponding to the selected image product are associated, via the graphical user interface with the images.

This application claims the benefit of U.S. Provisional Application No. 60/506,007 filed Sep. 24, 2003.

### FIELD OF THE INVENTION

The present invention is directed to a method to process images and a method to fulfill orders for photographs.

### SUMMARY OF THE INVENTION

The present invention is directed to a method to process images. A file (e.g., zip file) is uploaded to the system provider. The uploaded file contains at least one of color images scanned from film photographed at an event, black and white images scanned from film photographed at the event and digitally captured images photographed at the event, along with a text data file containing information pertinent to the uploaded images. After the uploading, images from the uploaded file are sorted, via the graphical user interface, into a series of images based on a user defined sorting sequence. The user defined sorting sequence may be comprised of at least one of a chronological order of the event, a grouping of images related to at least one individual, a grouping of images related to at least one subject, and a grouping of images related to holidays. After the sorting, at least one image product is selected, via the graphical user interface. The one image product is comprised of at least one of an event web site, a client proofing product, a CD/DVD slide show, a proof book and proofs. After the selecting, one or more image product categories are associated, via the graphical user interface. Then at least one selected image product corresponds with the images.

The present invention is further directed to a method to process images. A first file is uploaded from a first source. The first file is comprised of images of a first media type and the first media type is selected from the group consisting of color images scanned from film photographed at an event, black and white images scanned from film photographed at the event and digitally captured images photographed at the event. A second file is uploaded from a second source. The second file is comprised of images of a second media type and the second media type is selected from the group consisting of color images scanned from film photographed at the event, black and white images scanned from film photographed at the event and digitally captured images photographed at the event. The first and second sources are different, and the first and second media types are different. Images from the first and second uploaded file are sorted, via the graphical user interface, into a series of images based on a user defined sequence. The images from at least the first and second files are merged into a common file.

The present invention is further directed to a method to fulfill an order for photographs. A user is presented online a plurality of images associated with an event. Selection information is received online from the user wherein the selection information includes the images from the plurality of images associated with the event and reproduction criteria for each image selected. The selection information is provided to a photographer that photographed the plurality of images at the event. A graphical user interface is provided that is responsive to the selection information. The graphical user interface allows the photographer to direct that at least a first image from the plurality of images be fulfilled by at least one of a first photography laboratory and a first local printing device and to direct a second image from the plurality images be fulfilled by at least one of a second photography laboratory and a second local printing device.

The present invention is further directed to a method for collaboratively selecting images. A file is uploaded to a system provider wherein the file comprised of at least one of color images scanned from film photographed at an event, black and white images scanned from film photographed at the event and digitally captured images photographed at the event, along with a text data file. A selection of images from the uploaded file is presented via a graphical user interface to at least one user. At least one image from the file is selected via the graphical user interface. The selected image is reviewed by a first and second user. The control over the graphical user interface is assigned by the first user to the second user. The reviewed image is directed, via the graphical user interface, to a photography laboratory for fulfillment.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 illustrates a system used in connection with the present invention;

FIGS. 2A-2C illustrates an exemplary graphical user interface that may be used for uploading images in connection with the present invention;

FIGS. 3A-3D illustrate an exemplary graphical user interface that may be used for sorting images in connection with the present invention;

FIGS. 4A-4B illustrate an exemplary graphical user interface that may be used for selecting and associating images to image products that may be used in connection with the present invention;

FIG. 5 illustrates an exemplary graphical user interface that may be used for categorizing images that may be used in connection with the present invention;

FIGS. 6A-6E illustrate an exemplary graphical user interface that may be used for merging images that are received from more than one source into one directory or splitting images from a single source into more than one directory that may be used in connection with the present invention;

FIGS. 7A-7H illustrate an exemplary graphical user interface that may be used for fulfilling an order for photographs that may be used in connection with the present invention;

FIG. 8 illustrate an exemplary graphical user interface that may be used for collaboratively selecting images for fulfillment that may be used in connection with the present invention;

FIG. 9 is a flow chart illustrating a method of a preferred embodiment of the present invention;

FIG. 10 is a flow chart illustrating a method of a preferred embodiment of the present invention;

FIG. 11 is a flow chart illustrating a method of a preferred embodiment of the present invention; and

FIG. 12 is a flow chart illustrating a method of a preferred embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

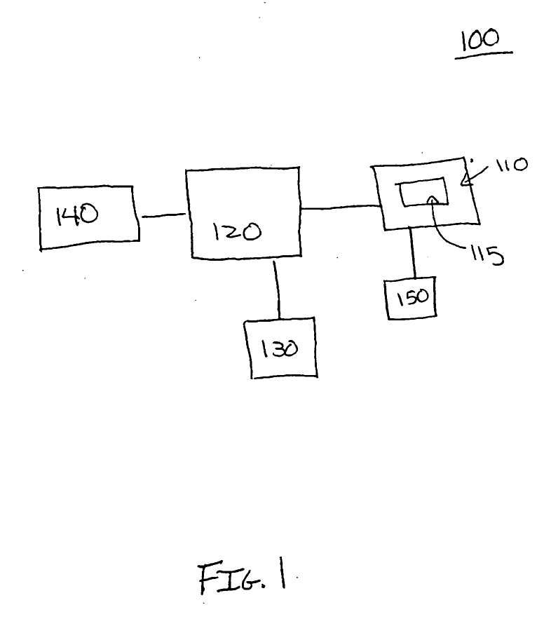

FIG. 1 illustrates system 100 that may be used to carry out the methods of the present invention. System 100 includes user computer(s) 110, graphical user interface (“GUI”) 115, network 120, photography laboratory 130, a system provider 140 and a local printing device 150. The network 120 may be comprised of a local area network (“LAN”), a wide area network (“WAN”) or the Internet. The user's browser accesses the GUI 115 at the system provider web site, enabling users to process images and fulfill an order for photographs. The images may be comprised of color images scanned from film photographed at an event, black and white images scanned from film photographed at the event and digitally captured images photographed at an event.

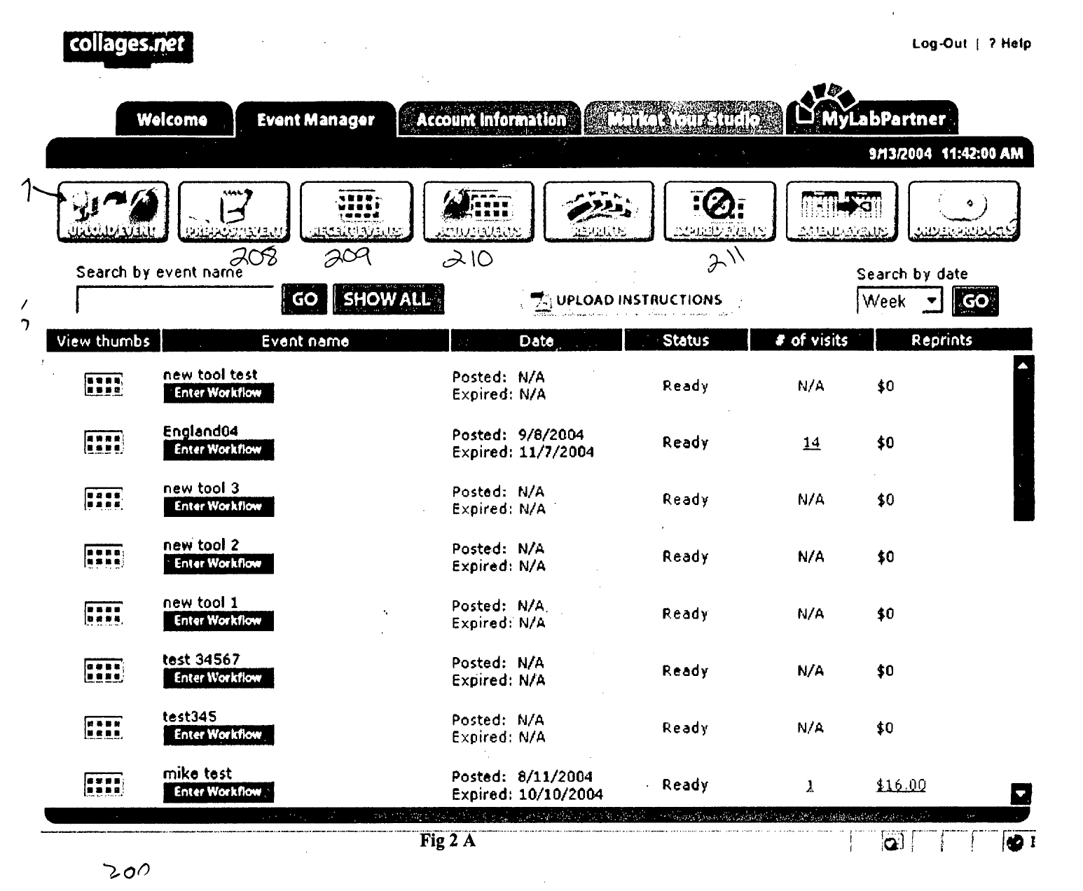

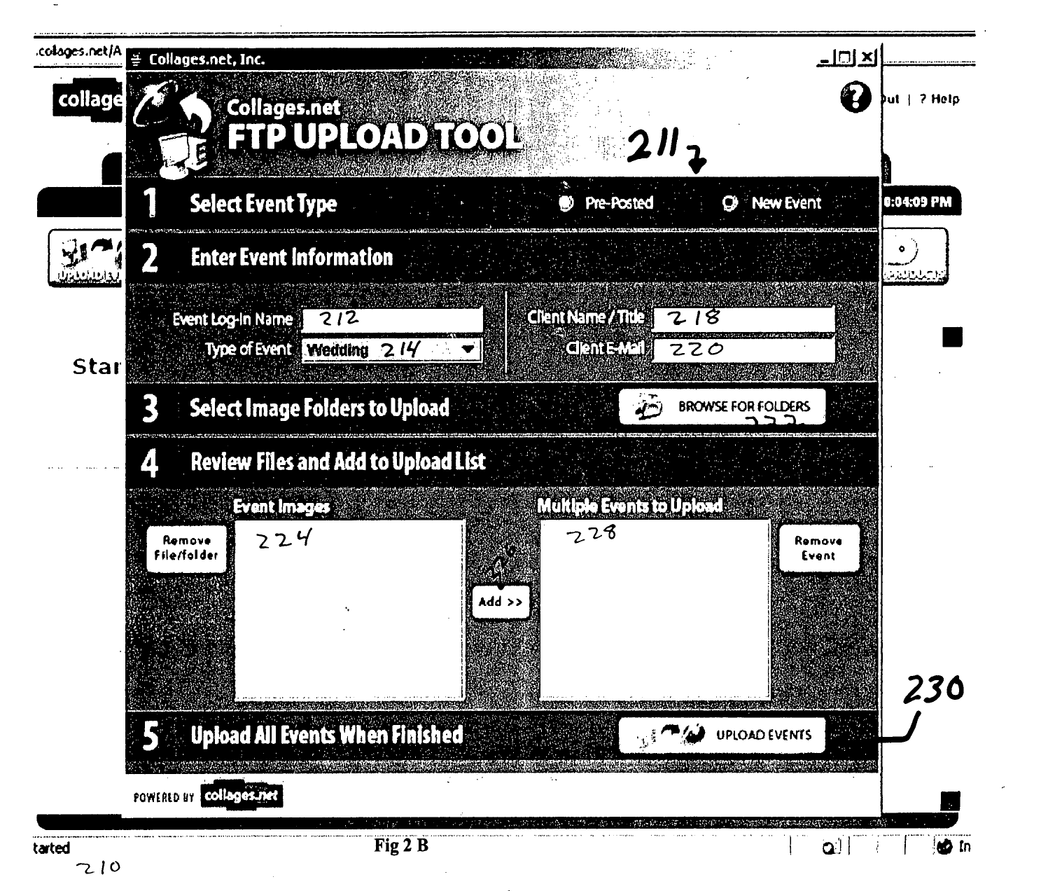

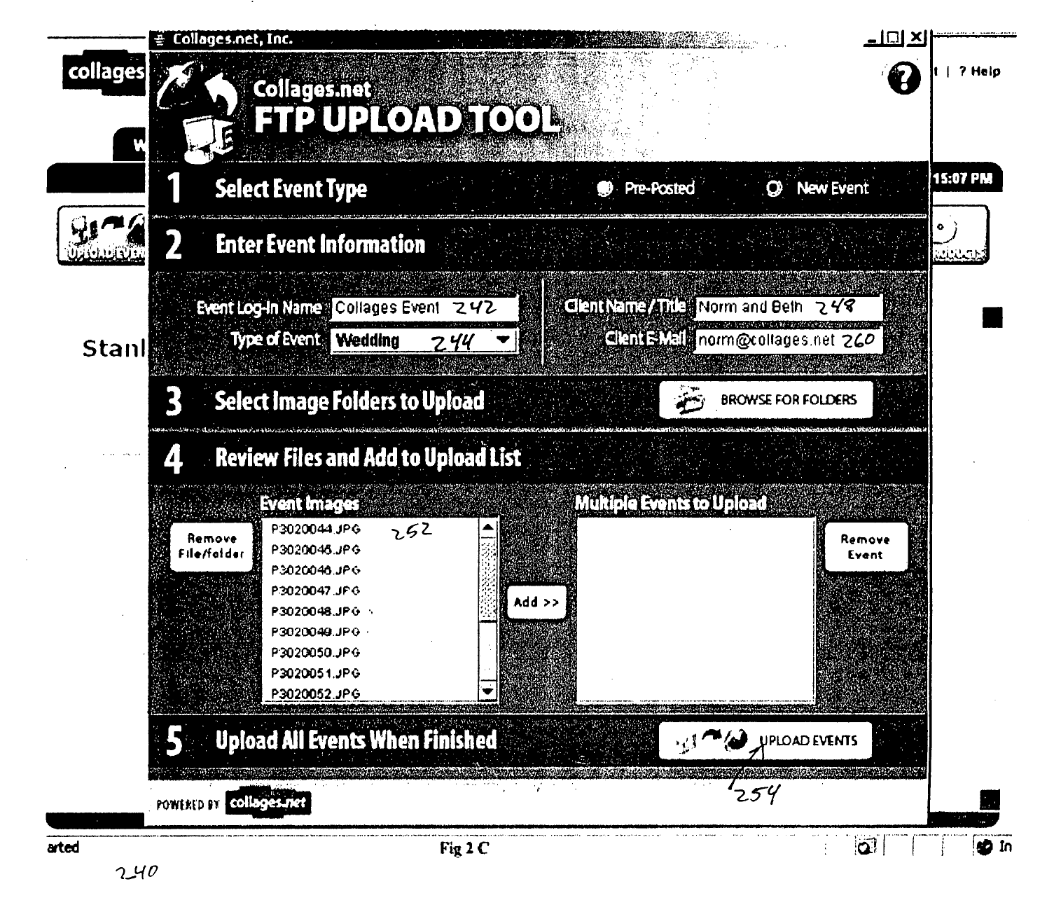

The images may be uploaded to the system provider 140 via two methods. The images are stored at the original source as individual jpeg files. In the first method, the GUI 115 is accessed via the user's browser allowing the user to upload a file containing a plurality of image files, (“event image file”), provide information regarding the event in a data file, wherein the user is the photographer, FIGS. 2A through 2C. A photographer may be a single photographer or photography studio with many photographers. The event image file(s) and an associated event data file are uploaded for processing via the event manager screen 200. The event data file contains information concerning the event, the file name and original file location. The event data file may contain information such as the type of event, Event log-in name, Client Name/Title, or Client email. Via GUI 115, the user uploads the event image file wherein each image was photographed at an event. To upload the file, the user accesses an event manager screen 200 containing an upload event button 207 which allows the user to upload an event. The user may also take other actions including pre-post event 208, review a list of recent events 209, review a list of active events 210 or review a list of expired events 211. A pre-post event allows the photographer to enter data about an event prior to the actual event taking place, a review active and review expired events presents a photographer with a respective list of each image for the event. The photographer may also upload additional images to a active, recent or expired events. The user selects upload event from the upload event button 207, FIG. 2A, which allows the user to upload a new event 211, FIG. 2B. From screen 210, the user can upload additional event image files by repeating the above uploading process, FIG. 2B, and filling the events to populate the upload bin 228 with additional events. The user then clicks the upload events button 230 to upload the image files. For each event, the user then enters the event information, such as event Log-in Name 242, the type of event 244, the client name 248, and client e-mail 260. After the user has entered the information necessary for an event, via GUI 115, the individual data files for the uploaded images 252 are displayed, FIG. 2C. The user is then notified that the events were uploaded successfully and the actual number of events that were uploaded.

The second upload method allows a photography laboratory 130 to upload image files using custom software (MLP lab software) provided by service provider 140, which resides on a server at the photography laboratory 130. The MLP lab software is automated and allows a minimal order entry information to be input through the use of a web based GUI if necessary. Photography laboratories may also integrate the application into their own systems, obviating the need for the web based GUI provided by service provider 140. The MLP lab software receives a specifically formatted data file from the photography laboratory 130, which is produced by the photography laboratory 130 during the order entry process or subsequent to the order entry process, and contains the network location of image files to be uploaded to service provider 140, customer and job information. Ingestion of a data file causes MLP lab software to retrieve digital image files from network 120, prepare a new data file which can be ingested by service provider 140, and to create a new zip file containing the image files and the new data file. The zip file is then uploaded to service provider 140.

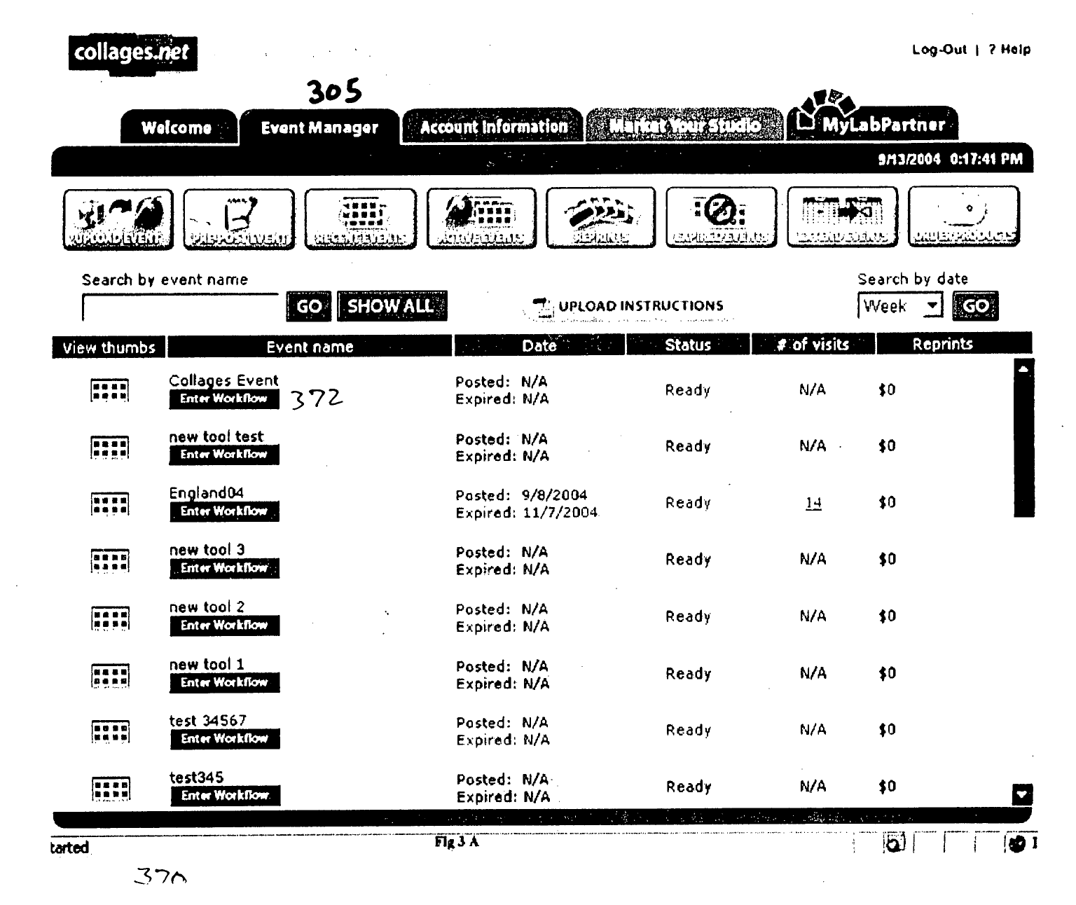

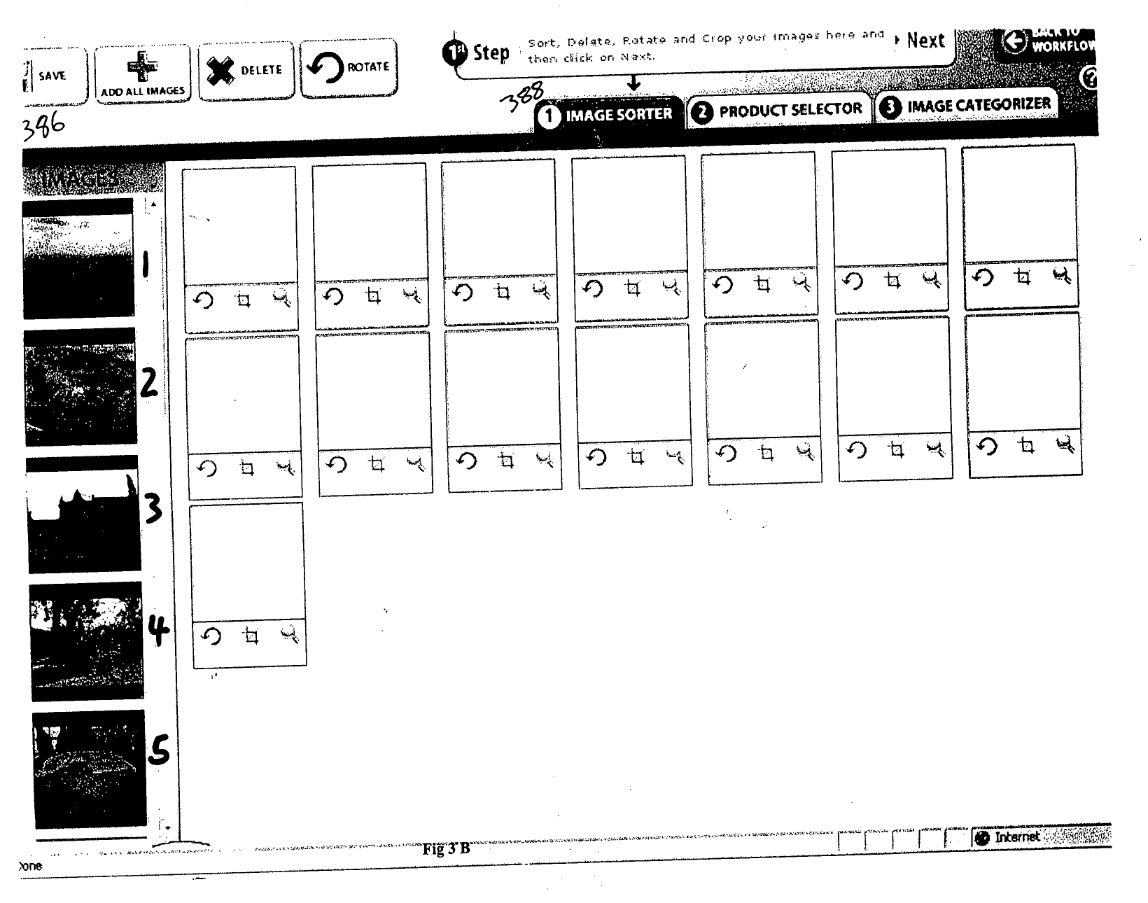

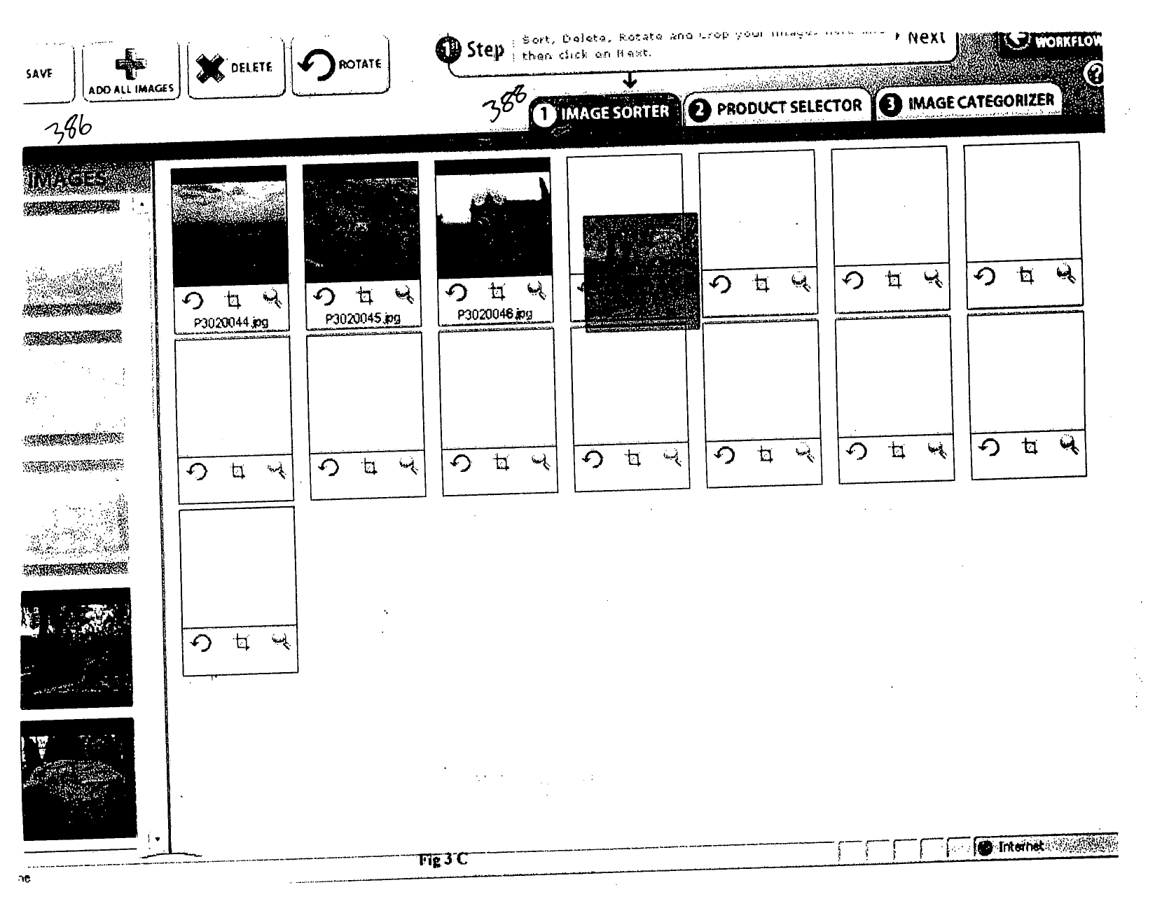

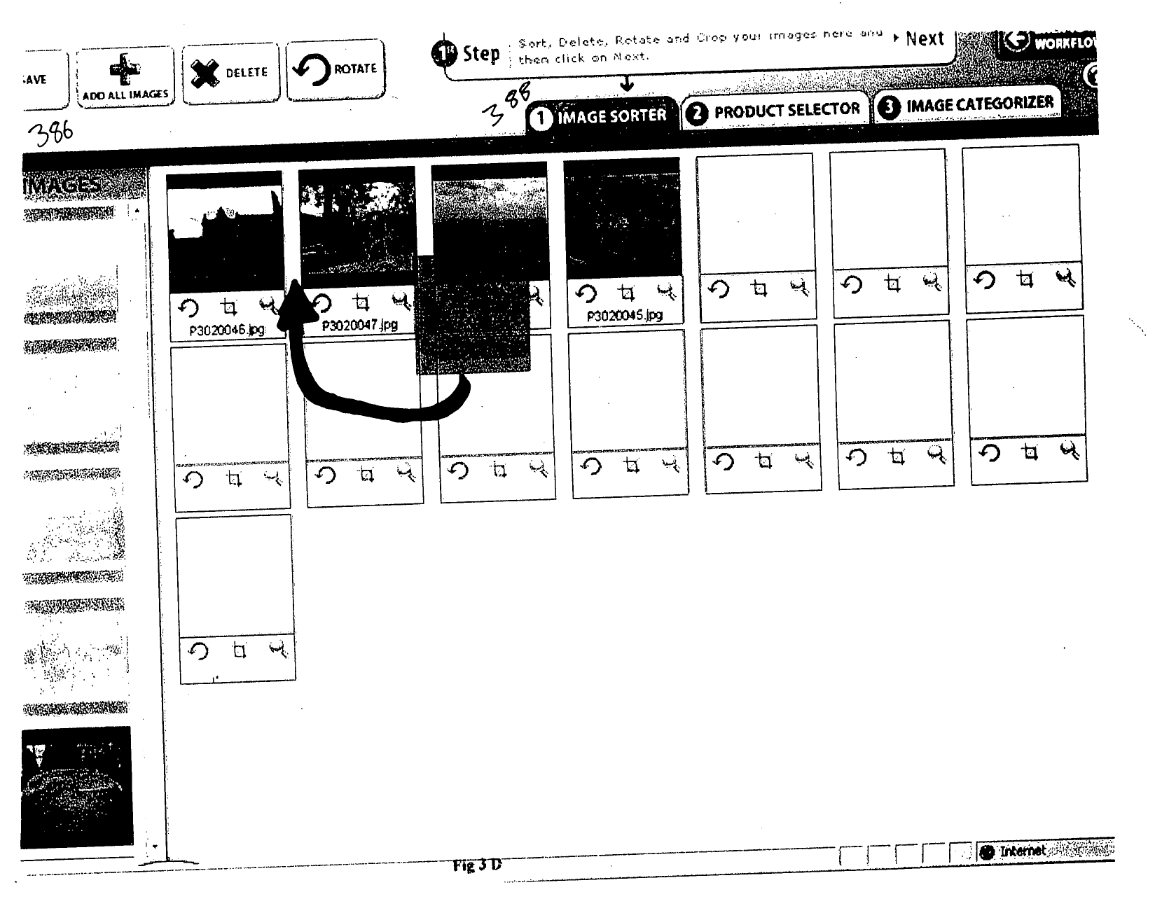

After the event image file is uploaded to the system provider, and before the image(s) of each event are sorted, the photographer confirms its order information and selects the next processing step. The uploaded images are then sorted as illustrated in FIGS. 3A through 3D. To sort the uploaded images, the user clicks the enter workflow button 372 for the event of interest in the event manager screen 370. The image sorter screen 385, of GUI 115, displays an image bin 386 and a light table 388, FIG. 3B. The user sorts images by clicking and dragging images from the image bin 386 to spaces on the light table 388. This allows the user to organize images from image bin 386 according to a user defined sorting sequence. For example, the user defined sorting sequence may include the chronological order of the event, grouping of images related to at least one individual, a grouping of images related to at least one subject, and a grouping of images related to holidays. In one embodiment, the event may be comprised of a wedding in which the images may be sorted by the wedding chronology, bride only, groom only, rehearsal dinner, etc. In another embodiment, the event may be comprised of a portrait shot in which the images may be sorted by the individual(s) in the portrait. For example in FIG. 3B, the image bin 386 contains five images, labeled one, two, three, four, and five, and the light table 388 is empty. The user then clicks and drags the images one through five to the light table 388. As shown in FIG. 3C the user has clicked and dragged images 1, 2, 3, and 4 to light table 388. Next the user can sort the images in a chronological order. As shown in comparing FIG. 3C to FIG. 3D, the user has organized the images by inserting images 3 and 4 before images 1 and 2 to establish the event chronology.

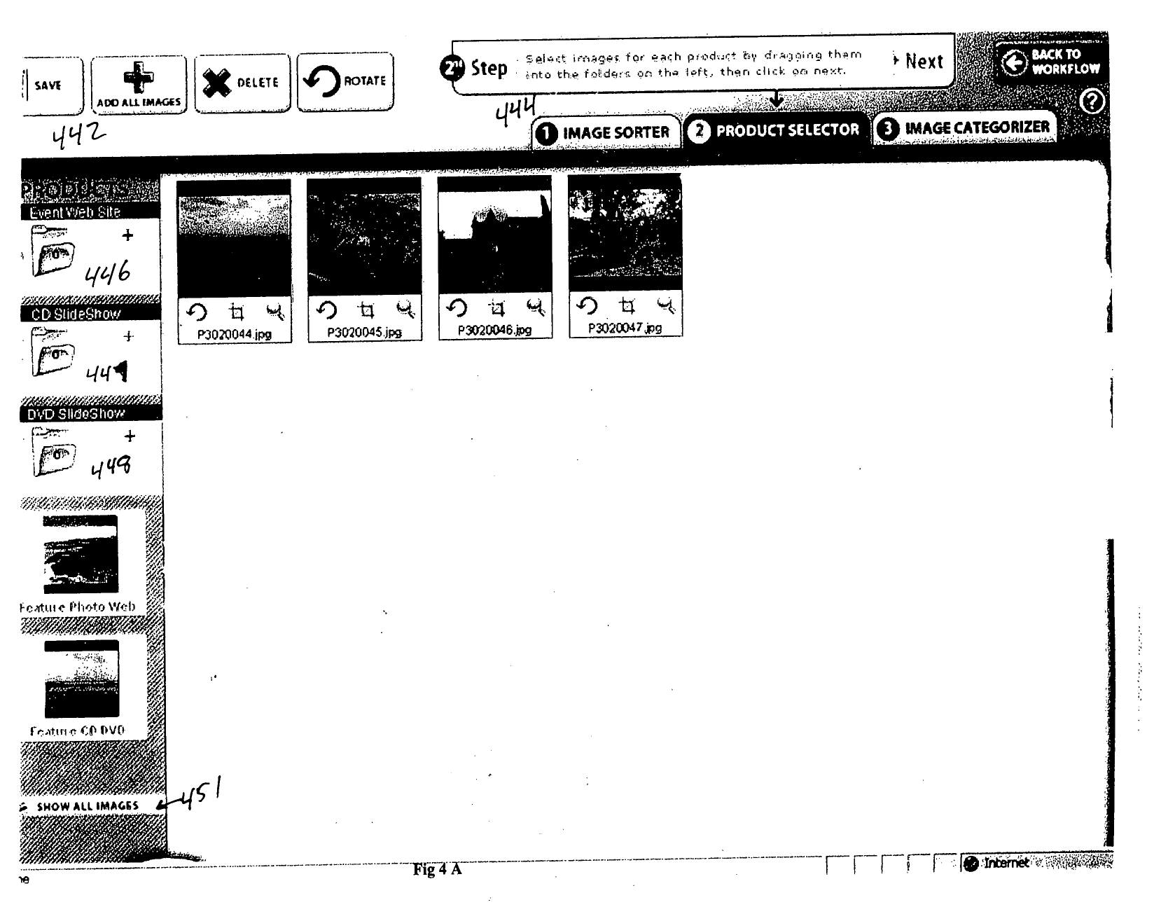

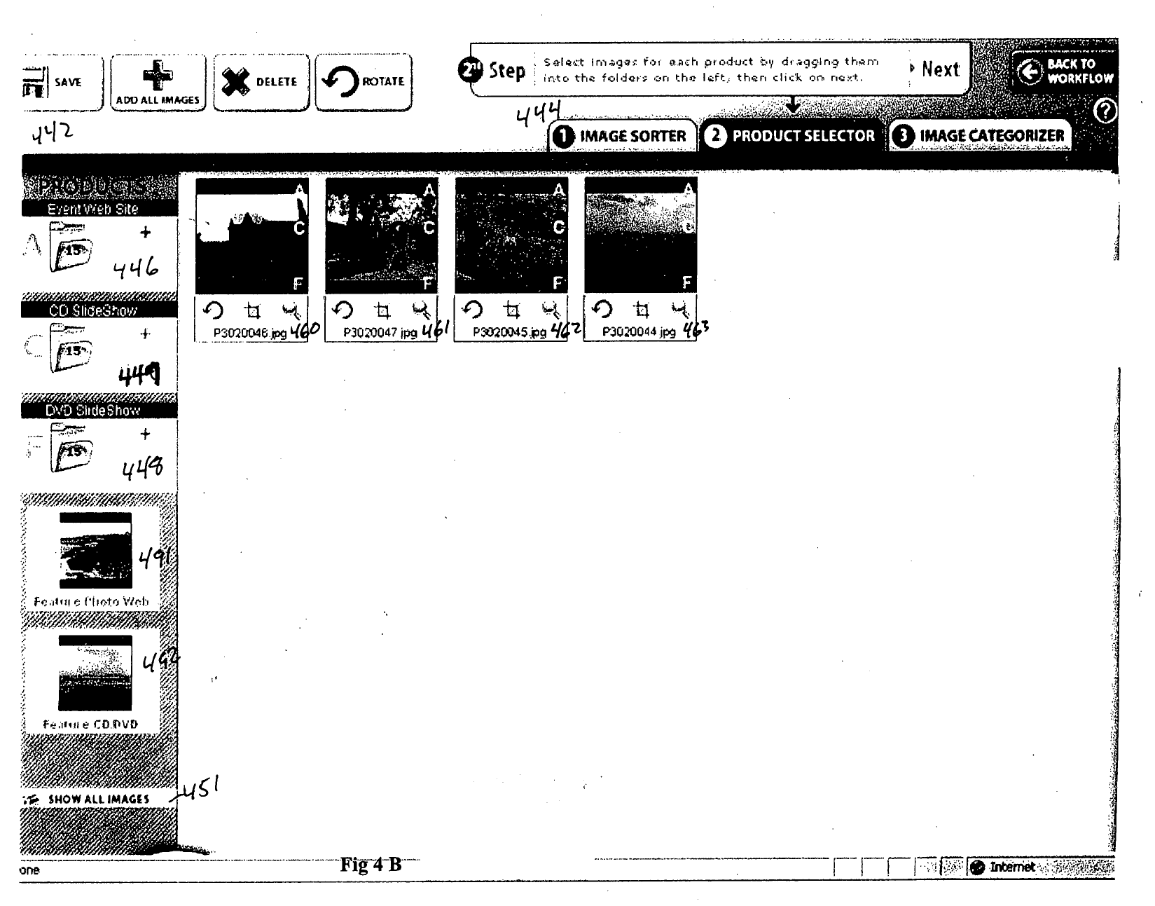

With reference to FIGS. 4A through 4B, the user then selects an image product to each image that the user has previously sorted. The user may select the various image products from the image product bin 442, as illustrated in 4A. The product image selector screen 440 contains the image product bin 442 where the image products may be comprised of an event web-site 446 which displays, at a web site, the event images uploaded, sorted and selected as described above. From the event web site, the event attendees may select images for fulfillment. The image products may be further comprised of CD slideshow 447, DVD slideshow 448, or show all 451. As illustrated in FIG. 4B, The light table 444 displays the images as previously sorted. The user selects the image products by clicking on the selected image in light table 444, dragging and dropping the image into product 446, 447, or 448.

After selecting images for the various image products, the images are associated with the selected product categories. This is shown by alphanumeric labels, that indicate product choices for each image, superimposed onto the images in light table 444. As illustrated in FIG. 4B, image 460, of screen 452, has labels A, C, and F, on the right side of the image, indicating that the user has selected and associated the event web-site, CD slideshow, and DVD slide show as image products for image 460.

Additionally, the user may select an image for display on the front cover of an image product, in FIG. 4B. Image product selector screen 490 displays feature photo-web 491, a feature photo-CD 492. FIG. 4B illustrates the image product selector screen 490 after the user has selected images from the light screen table 474 for display on front cover of the various image products 491, and 492.

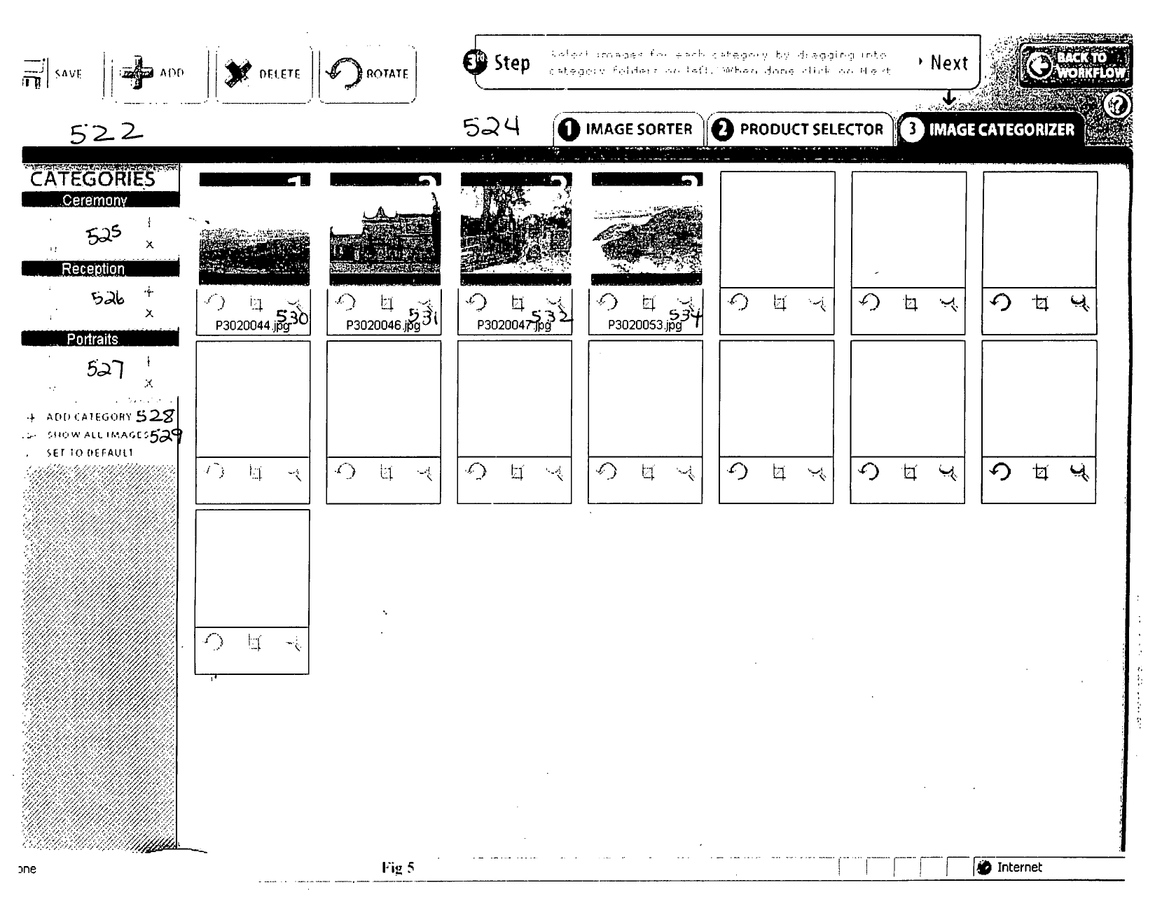

With reference to FIG. 5, the user may also categorize the images that the user had sorted, selected and associated with an image product category in the previous steps. As shown in screen 520, the user may select particular categories from the category bin 522 for connection with images 530, 531, 532, 533, 534, 535. The user has the capability to rename the existing default category names and to also add additional categories 528. The categories may be comprised of ceremony 525, reception 526, portraits 527 as shown in the light table 524. The user then clicks and drags an image from the light table 524 into category bin 522 to connect a particular image displayed in the light table 524 with the category.

The above described method advantageously allows a photographer to use a web-based GUI or client based GUI to interact with a web-based GUI to sort uploaded images scanned from film and digitally captured images, select image products, and finally categorize the images for web site presentation at an event web site. The photographer has a unique and time-saving workflow advantage that allows management of all images, image posting, and product ordering, from film scans. The photographer performs these steps from one central location and does not need to touch or manage film.

Once this series of steps is completed, the user pays service provider 140 via the internet with a credit card for the products ordered. Images are then proof marked and resized for each product selected, and delivered by service provider software to the appropriate destination for either web site display or product manufacturing (e.g., CD slideshow, DVD slideshow, etc). The delivery destination can be anywhere on the network 120.

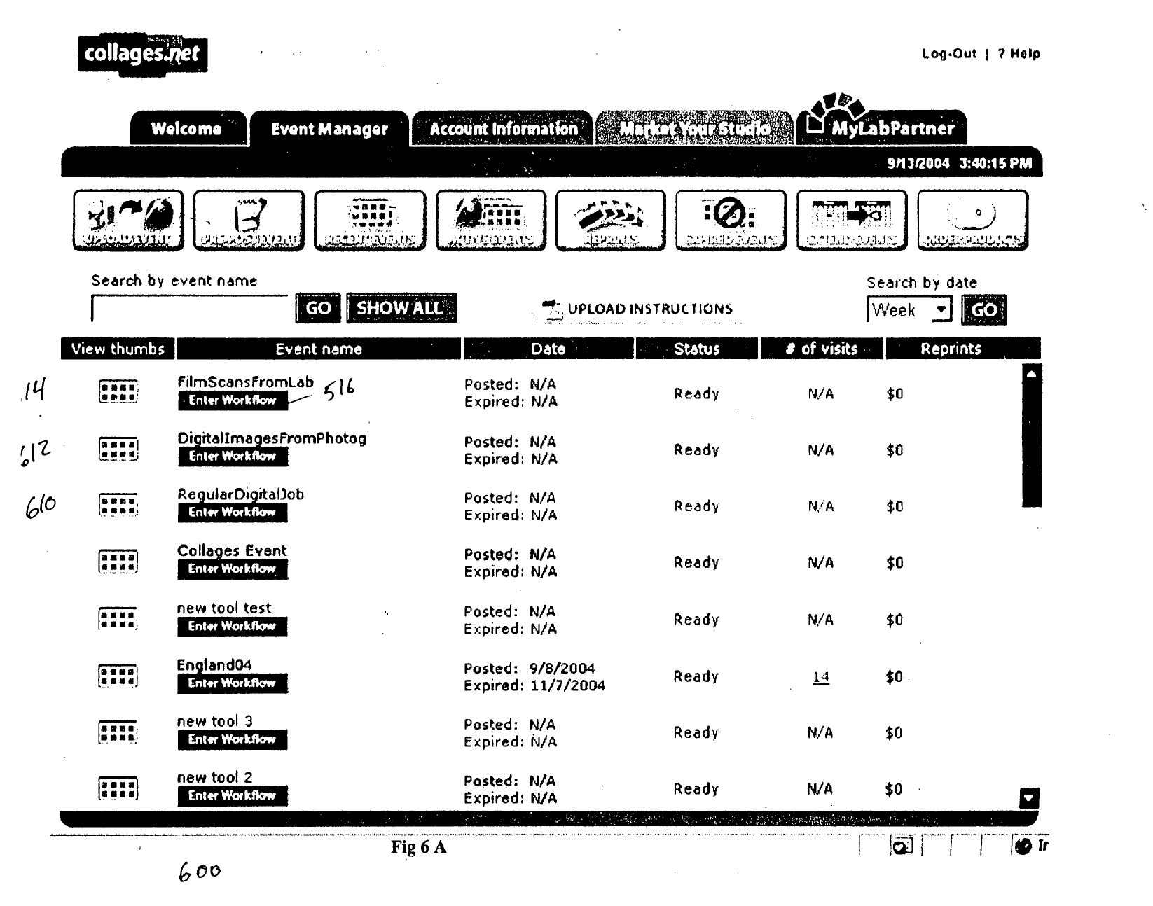

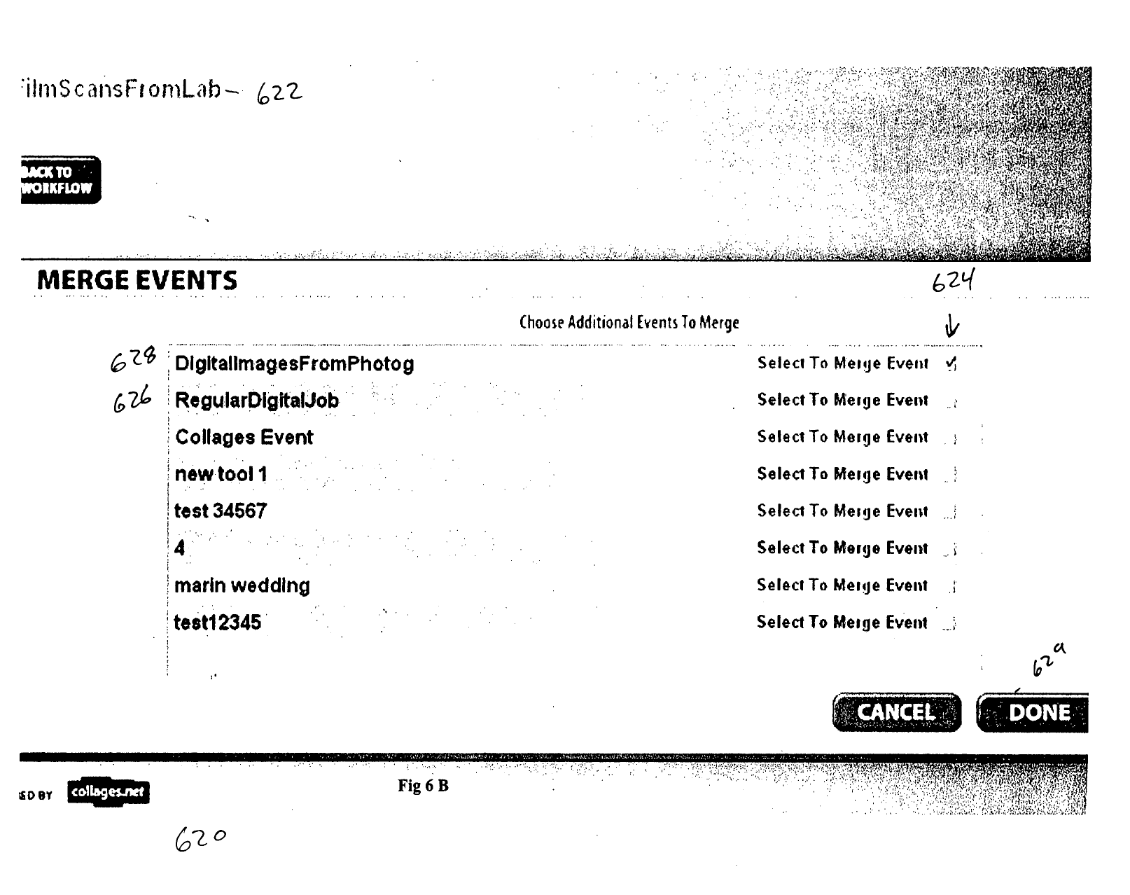

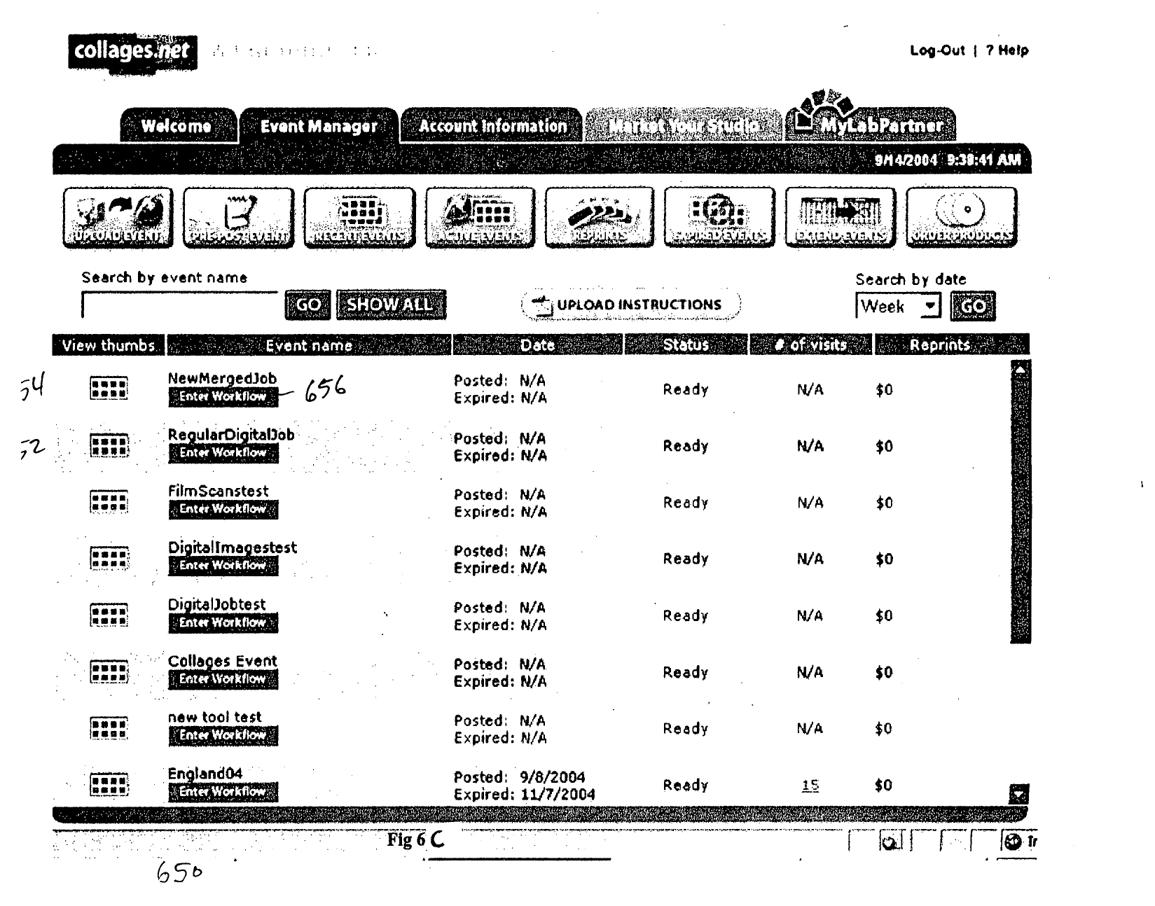

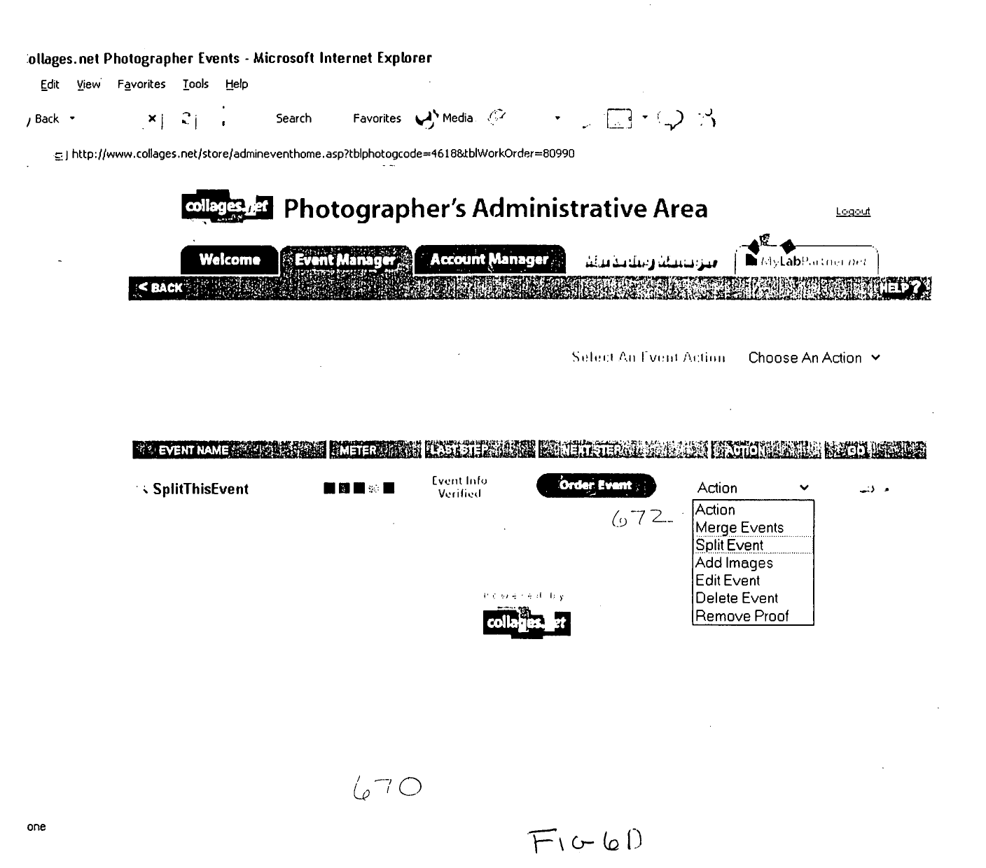

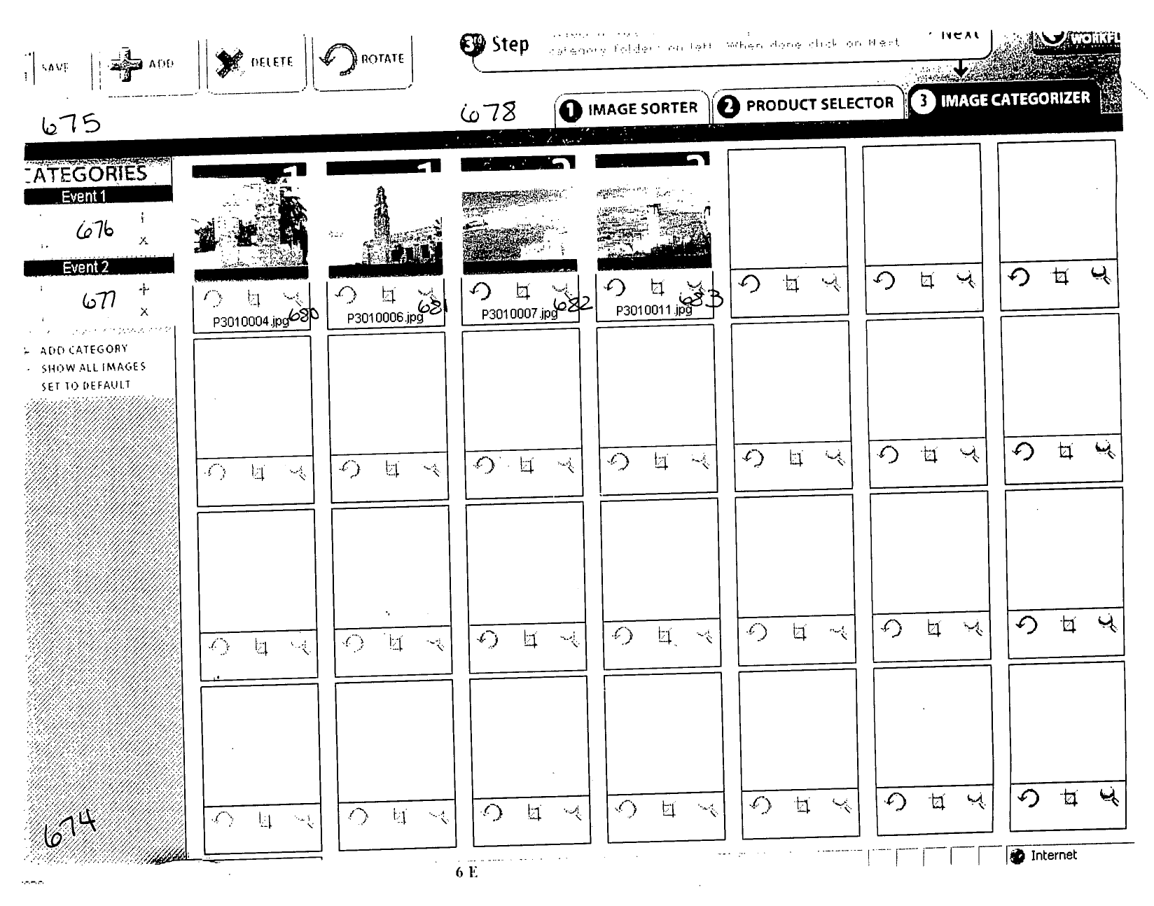

The present invention also allows the user to merge and sort images coming from different sources such as different photography laboratories or different media types as illustrated in FIGS. 6A through 6E. The media types may be comprised of color film, black and white film and digitally captured images photographed at an event. The event manager screen 600 displays three events 610, 612, and 614, each containing image files, that the user has uploaded. The user may choose to sort the images or may choose to merge the image files of one event with image files from another event into a new file. Event manager screen 620 illustrates the first event 622 containing image files chosen for merge, FIG. 6B. The user chooses an additional event 628 containing image files to merge with the first event 622, by clicking done button 629, FIG. 6B. During the update process, the database is updated with changes pertaining to image file location and then a single directory is created by combining all the image files from the first event and image files from the second event into a single directory. The merging of events is verified in event manager screen 650 where the event name 654 has changed to new merged job 654, FIG. 6C. Once the image files are merged into a single event file, the user may then proceed with sorting, selecting and associating images as discussed previously for a single event image collection.

The event manager screen also allows the user to sort the image files of a first event individually and then merge the image files of the first event with the image files of a second event. The user sorts the images of the first event as described above. The user then merges the first event file with a second event file into a new file while maintaining the image sort order of the first event file. The images of the second event file are placed below the sorted images of the first event file. The user then sorts the merged images of the second event file into the sorted images of the first event file for a final image ordering.

After the uploading, the selecting, and the sorting steps, which are graphically represented in the GUI, are recorded in a database. The database then determines any subsequent display, location, orientation and categorization characteristics for each image.

With reference to FIGS. 6D-6E, the present invention also provides for splitting an image folder of an event into two or more image event folders. The event manger screen 670, of GUI 115, displays the action drop down screen 672. The image splitter screen 674 allows the user to split the plurality of images displayed in the light table 678 into folders for event one 676 and event two 677 of the event bin 675, FIG. 6F. The user splits images 680 and 682 into a folder for event one by clicking and dragging the images 680 and 682 from the light table 678 into event one bin 676, FIG. 6F. The user can then split images 683, 684 and 685 into event two folder by clicking and dragging the images 683, 684 and 685 from the light table 678 into event two bin 677. The images are then labeled with the new events. The user then starts the select, sort and association process for each newly created event folder. This splitting step allows a film photographer to shoots several rolls of film for several different events. The photographer may then send the rolls of film to the color laboratory for development and then later create a unique website for each event.

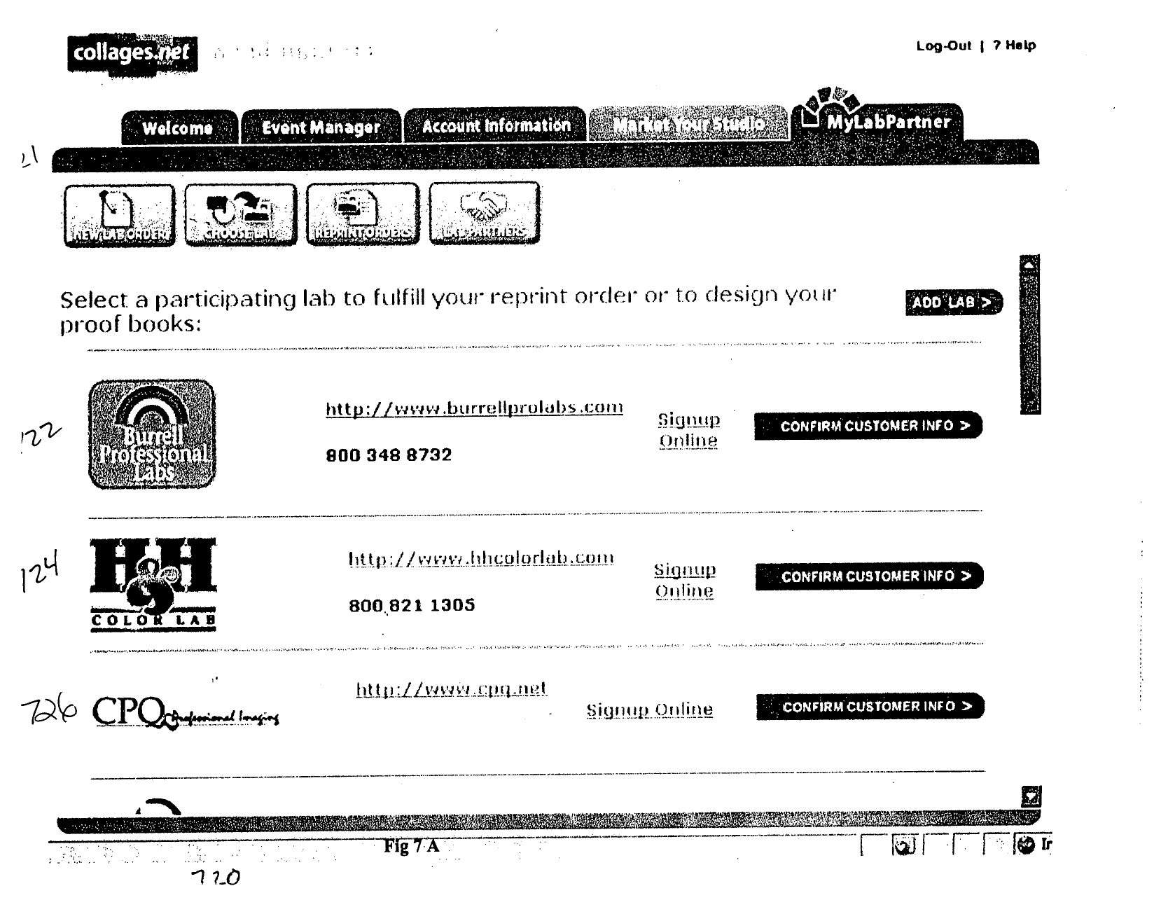

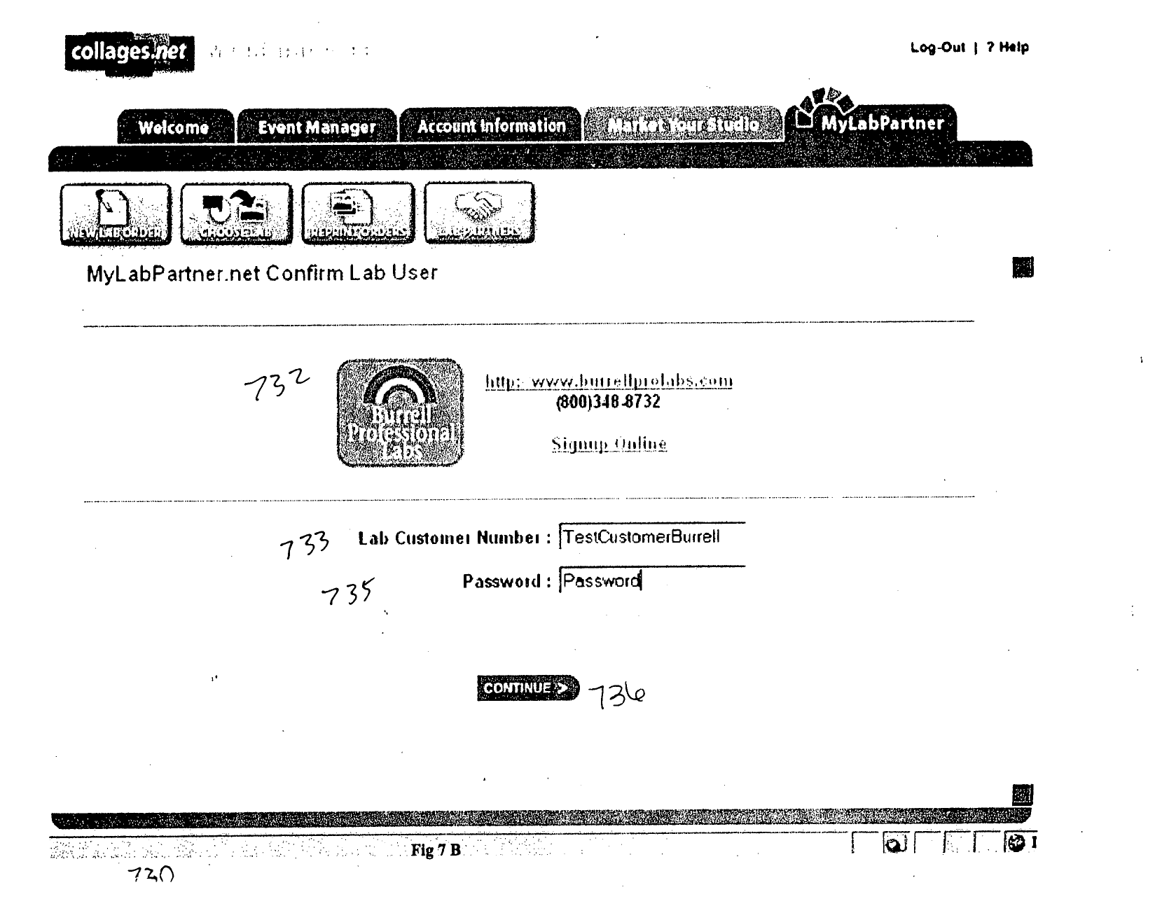

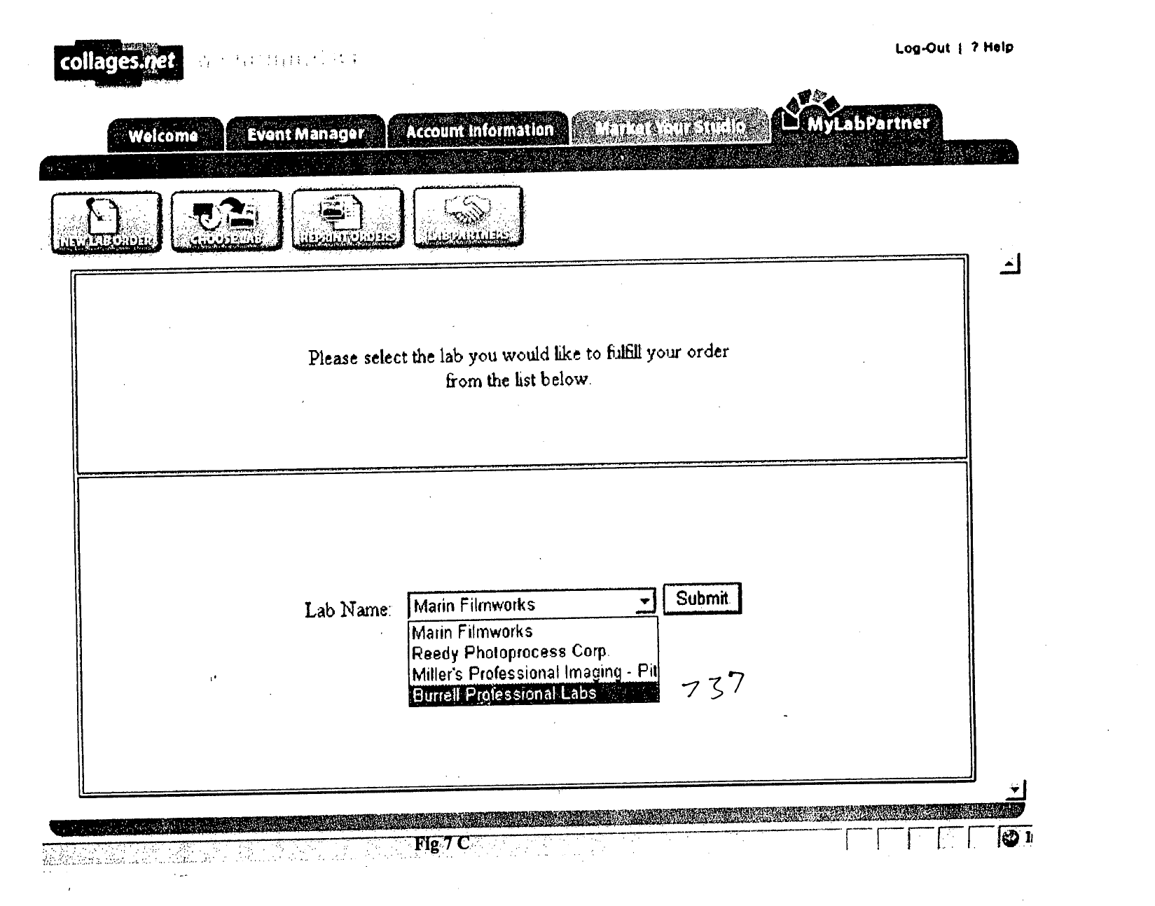

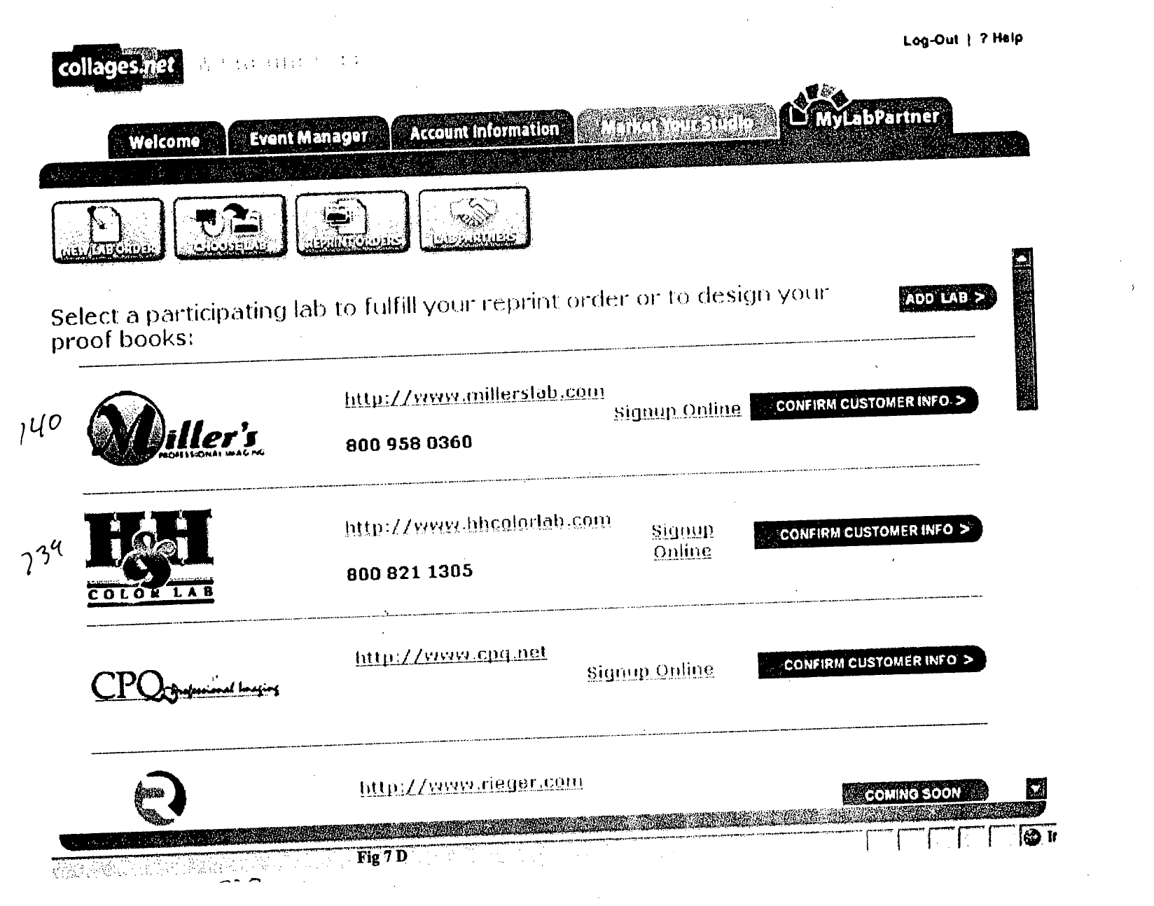

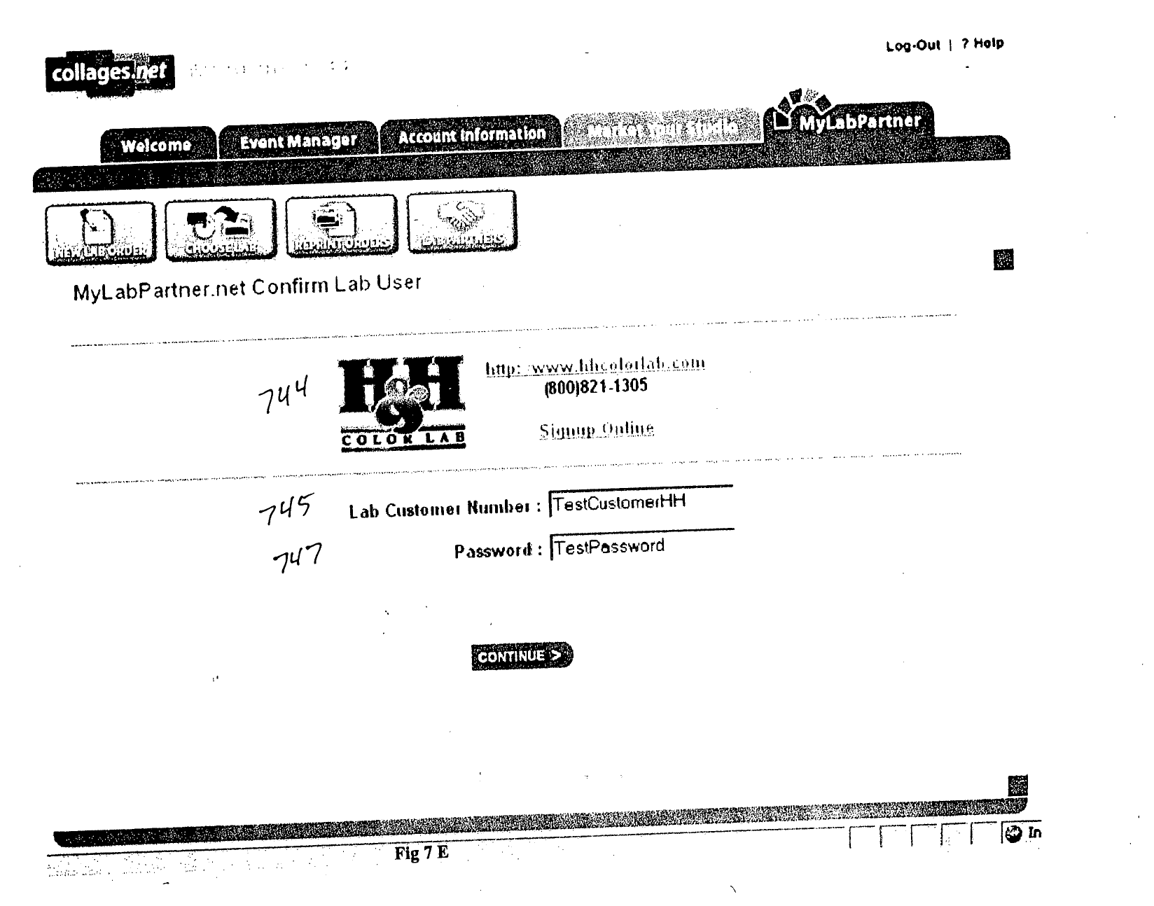

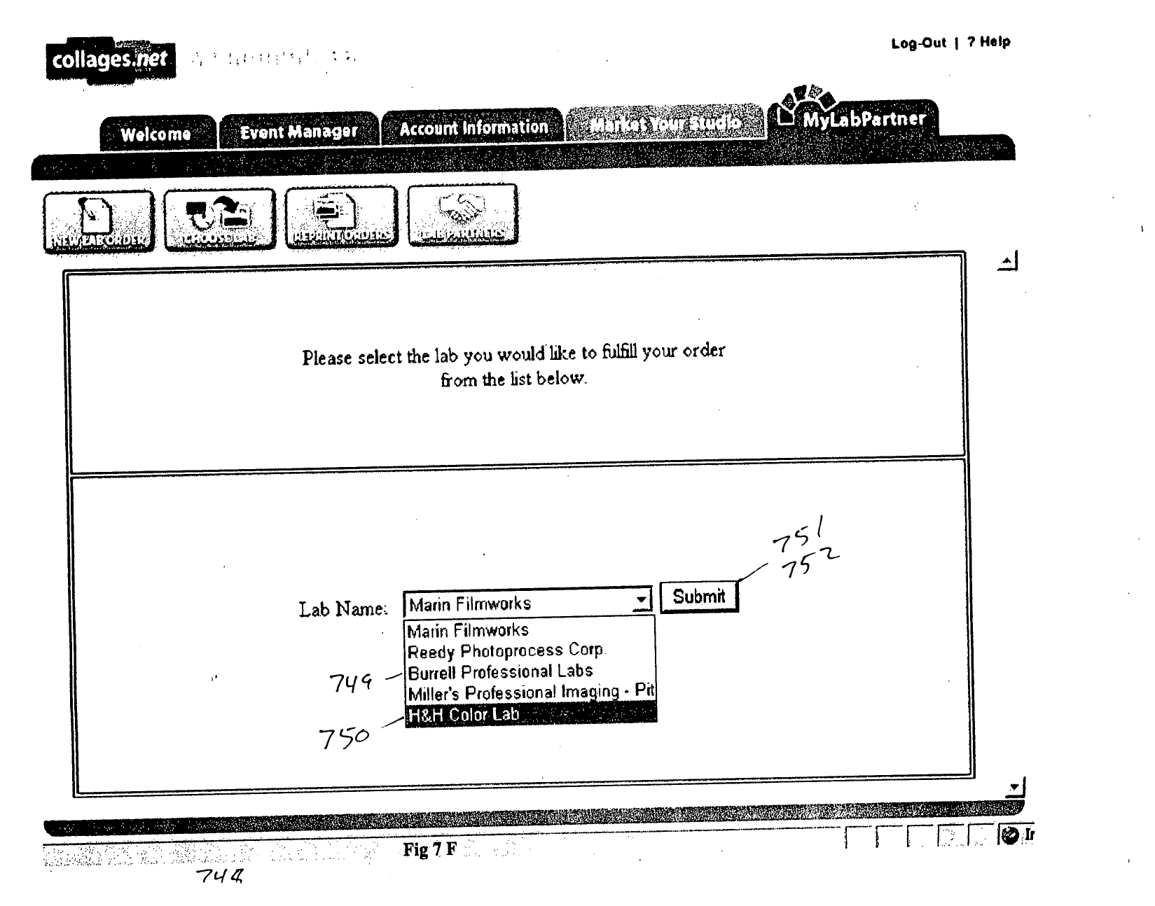

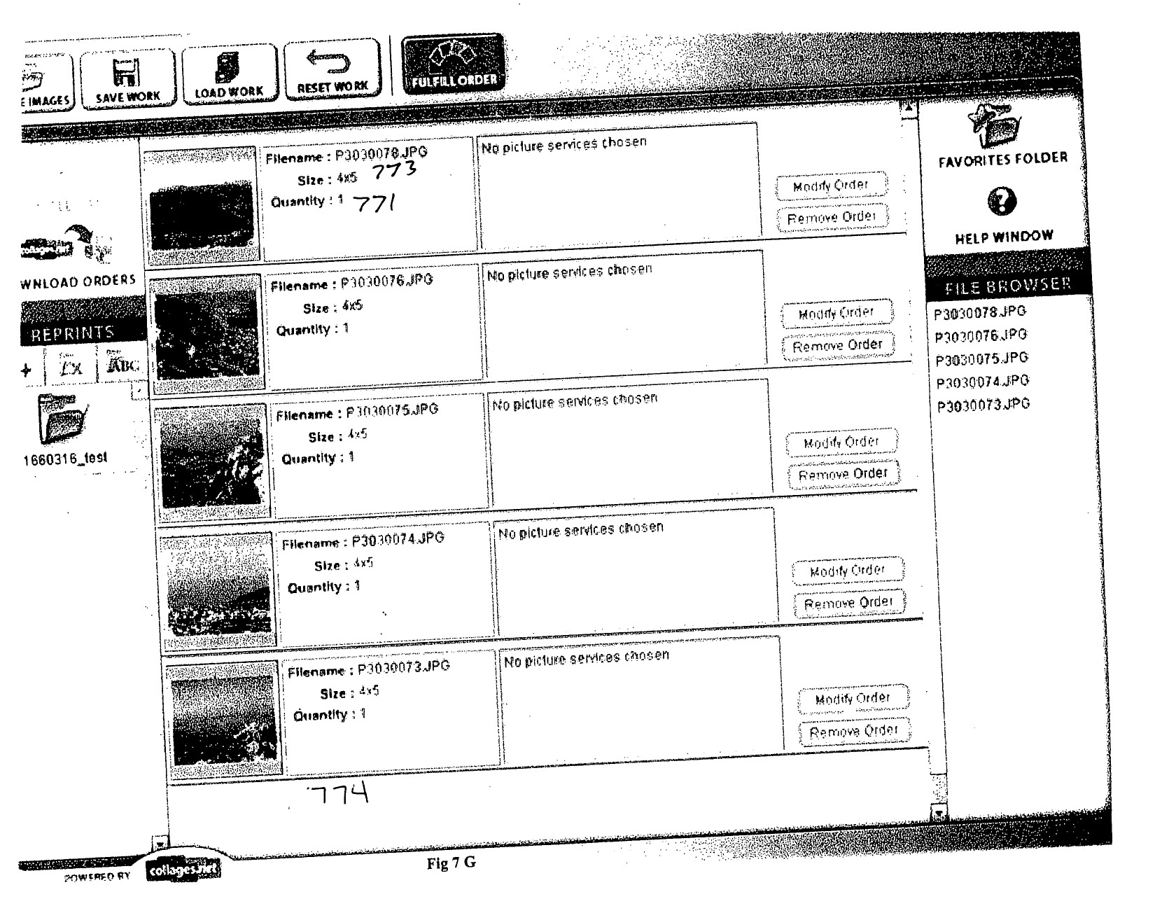

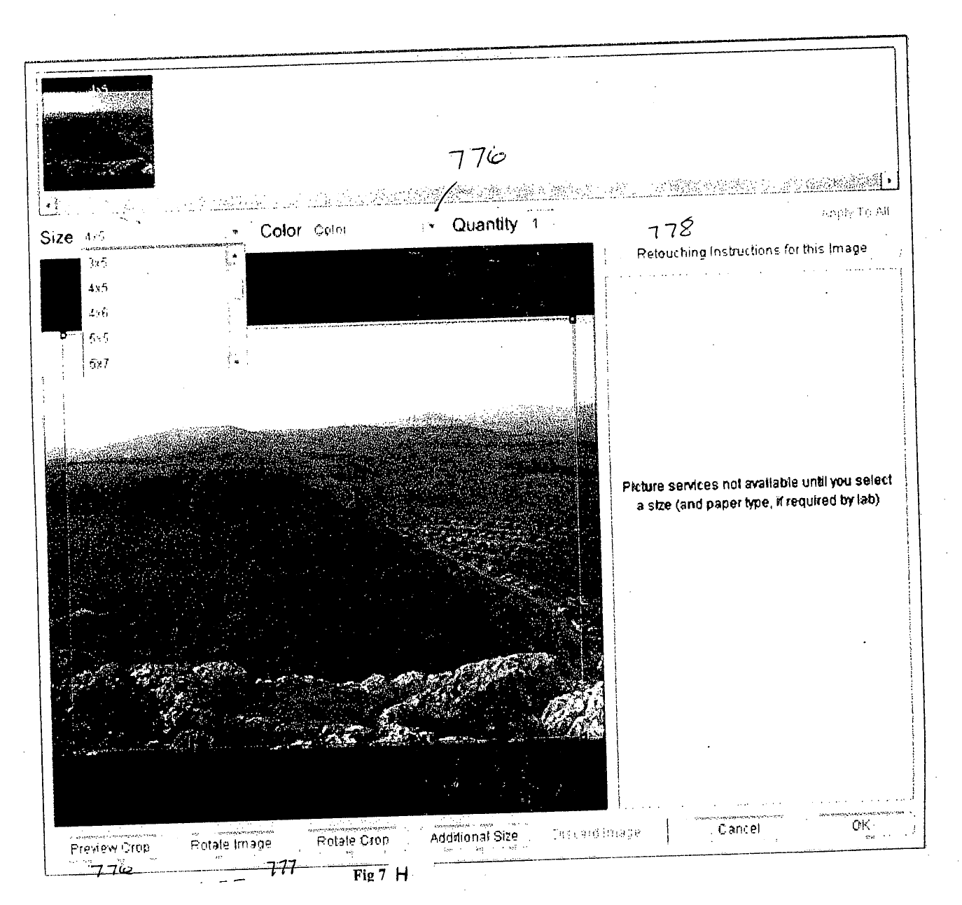

The present invention also provides for a method to fulfill an order for photographs. A plurality of images, stored in an event image file, associated with an event is presented online, at an event web site, to the user wherein the user is the end customer. The end customer may be comprised of a subject of the event or an event guest. The event web site displays a subset of all the images taken at an event. The plurality of images, presented in the event web site, are those the photographer has uploaded, sorted, selected and associated as previously described. The user reviews, online, the plurality of images presented at the event web site and then selects at least one of the images for fulfillment. The user also specifies the reproduction criteria for at least one image. The user creates selection information, which includes the identification of at least one image selected from the plurality of images and its reproduction criteria. The selection information is received online from the user. The selection information may include size of image, color of image (color, black & white, sepia) or cropping information. The photographer, who photographed the event, is provided online the user's selection information. With reference to FIGS. 7A through 7G, the photographer can select one or more photography laboratories to fulfill an order for the image(s) selected by the user and associated with the event. The photographer accesses GUI 115 via the photographer's browser, to select a photography laboratory. Screen 720 shows various photography laboratories 722, 724, and 726 that the photographer may select for fulfillment of an order for photographs, FIG. 7A. The photographer selects the first laboratory for fulfillment by clicking on photography laboratory 722. The photographer may also select a local printing device for fulfillment. As illustrated in FIG. 7B, screen 730, of GUI 115, displays the first photography laboratory selected by the photographer as well as information related to the photographer such as the lab customer number 733, and the password 735 for access to the lab's web site. The photographer then clicks the continue button on screen 736 and continues to screen 738 for selection of a second photography laboratory that can be used for fulfillment, 739 or 740, FIGS. 7C and 7D. Screen 742 displays the second photography laboratory selected by the photographer as well as information related to the photographer, such as the lab customer number 745, and the password 747 for access to the lab's web site, FIG. 7E. The photographer then clicks the submit button 751 to select the photography laboratories, FIG. 7F. The image(s) selected by the end customer populate the image bin 774, FIG. 7G. The photographer then assigns the images selected by the end customer shown populating the image bin 774, FIG. 7G for fulfillment at either the first or second photography laboratory. The photographer selects, via screen 770 of GUI 115, the reproduction criteria, from the user selection information, for each selected image, e.g., quantity of photographs 771, color or black and white photographs, and photograph size 773, FIG. 7G. The photographer also uses screen 775 of the fulfillment tool to crop images 776, to rotate 777 and add retouching instructions 778 prior to sending order to lab for printing. All order information, along with orders for other photographic products, such as a proof book, proofs, reprints, or album design from a third party vendor and the images selected for printing are transmitted, via the network 120, to one or more photographic laboratories.

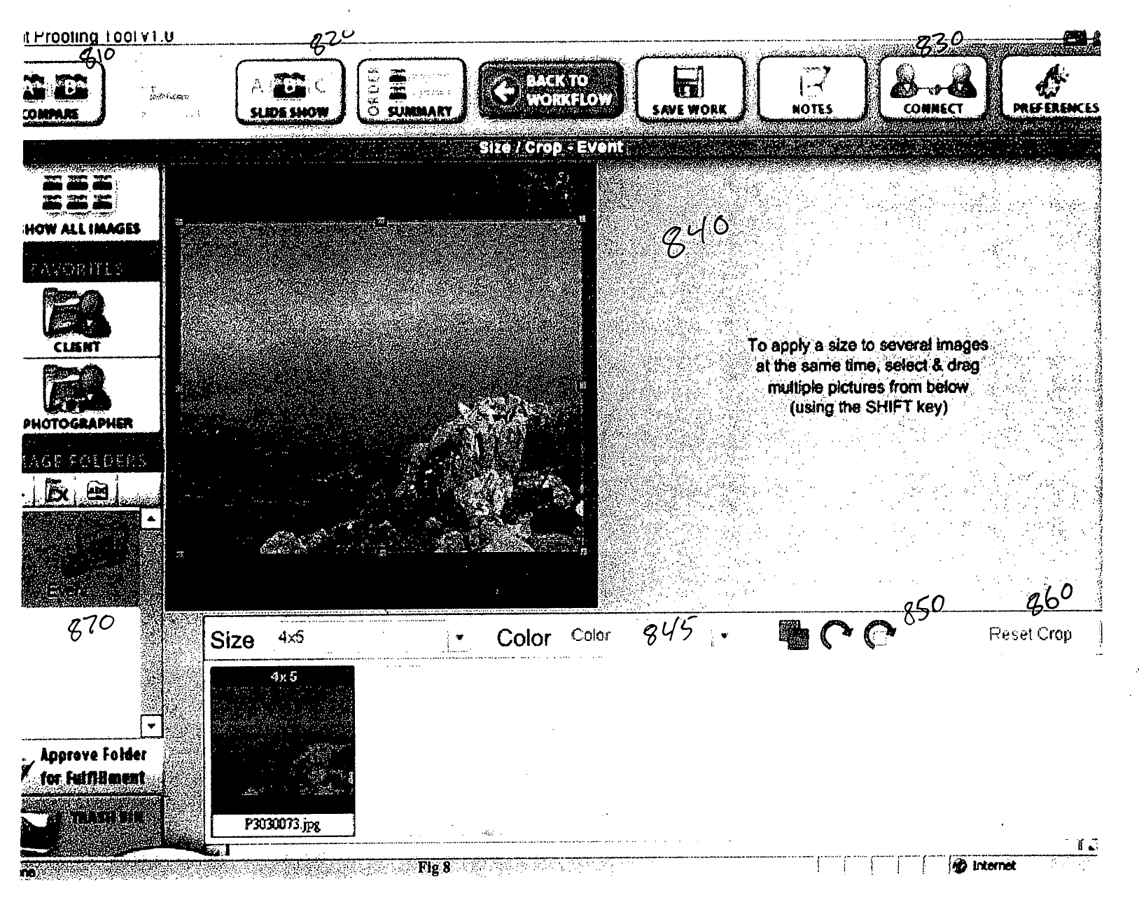

The present invention further provides for a method for real time collaborative selection of images by at least one user. The first and second users are not physically located at the same site during the collaboration. The first and second user may also communicate in real time via conventional telephonic means or via instant messaging. The user may include the photographer and end user. As illustrated in FIGS. 2A through 2C, a file is uploaded to a system provider where the file is comprised of at least one of color images scanned from film photographed at an event, and/or black and white images scanned from film photographed at the event and digitally captured images photographed at the event, along with a text data file. As further illustrated in FIG. 8, the selection of images from the uploaded file is presented, via a GUI, to at least one user. One of the users selects, via the GUI at least one image from the file 840. The first and second users review the selected image. A variety of review options are available to the users. The review process may include comparing a first and second selected image 810. The review process also includes manipulating steps such as rotating the selected image 850, cropping the selected image 860, zooming in on the selected image 840, previewing the selected image in black and white 845, adjusting the brightness of the selected image or adjusting the contrast of the selected image. The selected images may be presented to the end customer as a slide show via the GUI 820. During the review process, the first user may also assign control over the GUI to the second user 830. After reviewing the selected image, the photographers directs, via the graphical user interface, the reviewed image for fulfillment 870 at a photography laboratory, FIG. 8.

This method for collaboratively selecting images advantageously provides for a web based device that allows a customer to select images when the customer and photographer are not located at the same site. The customer and photographer may view the images via a client web site while at the same time the customer may direct specific inquiries to the photographer about images by comparing or manipulating images. The customer may also view, compare or manipulate the images and then place an order for fulfillment without interaction with the photographer.

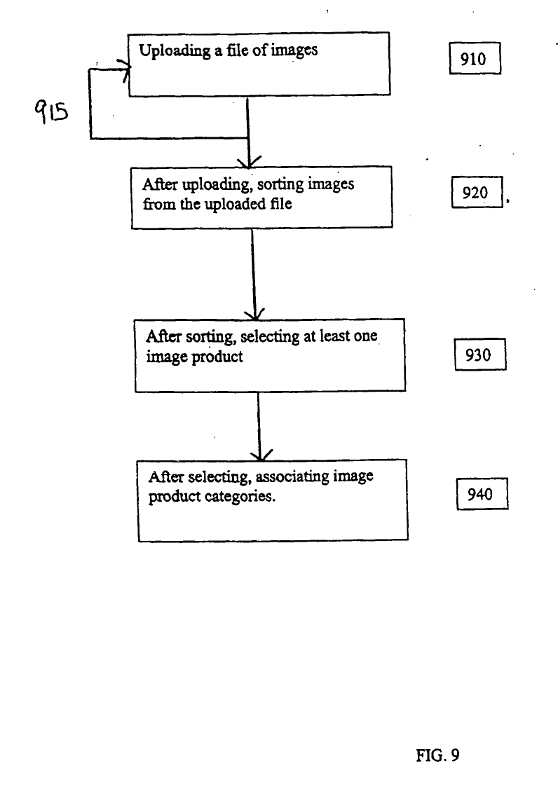

With reference to FIG. 9, a flowchart is shown illustrating a method of the present invention to process images. In step 910, a user uploads a file comprised of data for color images scanned from film, and/or black and white images scanned from film and/or digitally captured images and a text data file. The color images, the black and white images and the digitally captured images were all photographed at the same event. The user may optionally upload a file of images photographed at a different event in step 915. After uploading the file, in step 920, the user sorts the images into a series of images based on a user defined sorting sequence. For example, the user defined sorting sequence may include the chronological order of the event, grouping of images related to at least one individual, a grouping of images related to at least one subject, and a grouping of images related to holidays. In step 930, after the sorting of step 920, the GUI is used to select at least one image product. The image product may be comprised of event web site, a CD slideshow, and a DVD slide show. In step 840, after the user has selected at least one image product of step 930, the user then associates one or more image product categories. The product categories correspond to at least one selected image product with the image.

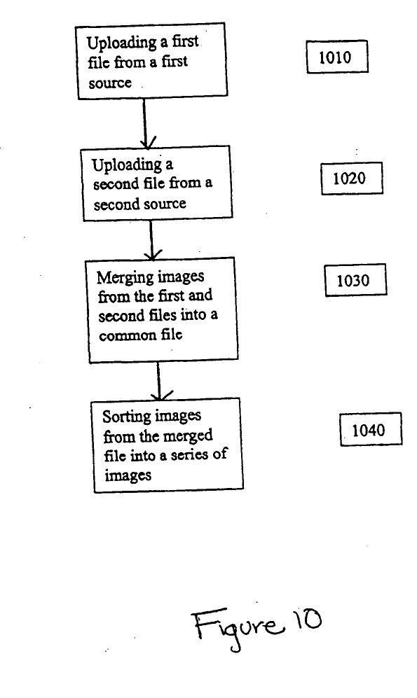

With reference to FIG. 10, a flowchart is shown illustrating a method of the present invention to process images of different media types and sources. In step 1010, a first file is uploaded from a first source. The first file is comprised of images of a first media type. In step 1020, a second file is then uploaded from the second source. The second file is comprised of images of a second media type. The first and second media types are selected from the group consisting of color images, scanned from film, and/or black and white images scanned from film, and/or digitally captured images. The black and white images, the color images, and the digitally captured images were all photographed at a common event. The first and second sources of files are different and the first and the second media types are different. In step 1030, images from the first and the second files are merged into a common file. In step 1040, images are sorted from the merged files are sorted based on the chronology of the event.

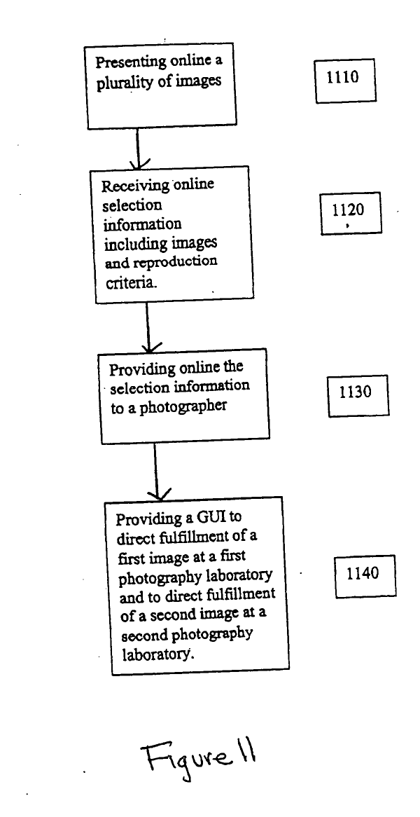

With reference to FIG. 11, a flowchart is shown illustrating a method of the present invention to fulfill orders for photographs from more than one photography lab. In step 1110 a plurality of images are presented online to a user wherein the user is the end customer. In step 1120, selection information is received online wherein the selection information includes the images selected from a plurality of images associated with an event and reproduction criteria. In step 1130, the user's selection information is provided online to the photographer who photographed the event. Next in step 1140 a GUI is provided to the photographer to direct fulfillment of a first image by at least one of a first photography laboratory and a local printing device and to direct fulfillment of a second image by at least one of a second photography laboratory and a second local printing device.

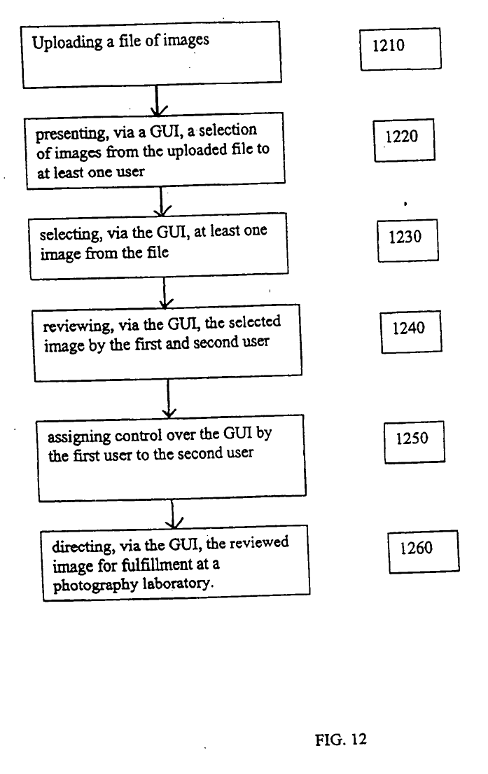

With reference to FIG. 12, a flowchart is shown illustrating a method of the present invention to collaboratively select images. In step 1210, a file is upload to a system provider wherein the file comprised of at least one of color images scanned from film photographed at an event, black and white images scanned from film photographed at the event and digitally captured images photographed at the event, along with a text data file. In step 1220, a selection of images from the uploaded file is presented via a GUI to at least one user. Next in step 1230, at least one image from the file is selected via the GUI followed by step 1240, where the selected image is reviewed by a first and second user. The first and second users are not located at the same site. In step 1250, the control over the GUI is assigned by the first user to the second user. In step 1260, the reviewed image is directed, via the GUI, to a photography laboratory for fulfillment.

The present invention may be embodied in other specific forms without departing from the spirit or essential attributes of the invention. Accordingly, reference should be made to the appended claims, rather than the foregoing specification, as indicating the scope of the invention. Although the foregoing description is directed to the preferred embodiments of the invention, it is noted that other variations and modification will be apparent to those skilled in the art, and may be made without departing from the spirit or scope of the invention.

1. A method to process images comprising the steps of:
uploading to a system provider a file comprised of at least one of color images scanned from film photographed at an event, black and white images scanned from film photographed at the event and digitally captured images photographed at the event, along with a text data file;
after the uploading, via a graphical user interface, sorting images from the uploaded file into a series of images based on a user defined sorting sequence wherein the user defined sorting sequence may be comprised of at least one of a chronological order of the event, a grouping of images related to at least one individual, a grouping of images related to at least one subject, and a grouping of images related to holidays;
after the sorting, selecting, via the graphical user interface, at least one image product comprised of at least one of an event web site, a client presentation product, a CD/DVD slide show, a proof book and proofs; and
after the selecting, associating, via the graphical user interface, one or more image product categories corresponding to the at least one selected image product with the images.

2. The method as in claim 1, wherein the uploading is via a graphical user interface.

3. A method to process images comprising the steps of:
uploading a first file from a first source,
wherein the first file is comprised of images of a first media type and the first media type is selected from the group consisting of color images scanned from film photographed at an event, black and white images scanned from film photographed at the event and digitally captured images photographed at the event;
uploading a second file from a second source,
wherein the second file is comprised of images of a second media type and the second media type is selected from the group consisting of color images scanned from film photographed at the event, black and white images scanned from film photographed at the event and digitally captured images photographed at the event,
wherein the first and second sources are different, and the first and second media types are different;
sorting, via a graphical user interface, images from the first uploaded file into a series of images based on a chronology of the event;
sorting, via the graphical user interface, images from the second uploaded file into a series of images based on the chronology of the event; and
merging images from at least the first and second files into a common file.

4. A method to fulfill an order for photographs comprising the steps of:
presenting online to a user a plurality of images associated with an event;
receiving online from the user selection information including images from the plurality of images associated with the event and reproduction criteria for each image selected;
providing online the selection of information to a photographer that photographed the plurality of images at the event; and
providing a graphical user interface, responsive to the selection information, that allows the photographer to direct that at least a first image from the plurality of images be fulfilled by at least one of a first photography laboratory and a local printing device and to direct a second image from the plurality of images be fulfilled by at least one of a second photography laboratory or a second local printing device,
wherein the user is not the photographer.

5. The method as in claim 4 further comprising:
directing a third image from the plurality of images be fulfilled by at least one of a third photography laboratory or a third local printing device.

6. A method to collaboratively select images comprising the steps of:
uploading to a system provider a file comprised of at least one of color images scanned from film photographed at an event, black and white images scanned from film photographed at the event and digitally captured images photographed at the event, along with a text data file;
presenting, via a graphical user interface, a selection of images from the uploaded file to at least one user, wherein the user is at least one of a photographer, an image subject and an event attendee not located at the same site as a first user;
selecting, via a graphical user interface, at least one image from the file;
reviewing, via the graphical user interface, the selected image by the first and second user;
assigning control over the graphical user interface by the first user to the second user; and
directing, via the graphical user interface, the reviewed image for fulfillment at a photography laboratory.

7. The method of claim 6, wherein the reviewing step comprises comparing at least two selected images from the file.

8. The method of claim 6, wherein the reviewing step comprises manipulating the selected image from the file.

9. The method of claim 8, wherein the manipulating step is comprised of at least one of rotating, cropping, zooming, previewing the selected image in black and white, adjusting the brightness and adjusting the contrast.
